(19) United States
(12) Patent Application Publication
(10) Pub. No.: US 2006/0020056 A1
(43) Pub. Date: Jan. 26, 2006

(54) Method for improved melt flow rate fo filled polymeric resin

(75) Inventors: Thomas Dombrowski, Allentown, PA (US); Stephen Andrew Hrizuk, Easton, PA (US)

Correspondence Address: Marvin J. Powell;Minerals Technologies Inc., One Highland Avenue, Bethlehem, PA, 18017, US

(73) Assignee: Specialty Minerals (Michigan) Inc.

(21) Appl. No.: 10/897,649

(22) Filed: Jul. 23, 2004

(51) Int. Cl. C08K 9/12; C08K 3/26

(52) U.S. Cl. 523/210; 524/425

(57) ABSTRACT

Fillers used in polymer applications are surface modified with an amine prior to compounding with a polymeric resin thus improving the melt flow rate and fusion times of the polymeric resin composition when compounded.

### FIELD OF THE INVENTION

The present invention relates to filled polymeric resin compositions. The present invention also relates to polymeric resin compositions wherein the filler has been surface treated or surface modified to improve its chemical compatibility with the polymeric resins, such that the filled polymeric resin composition has improved melt flow rate and reduced fusion times.

The products formed from the filled polymer resin of the present invention exhibit impact strength, tear strength, flexural modulus, loading level and tensile strength. Additionally, the surface treated filler is suitable for use in thermosetting and thermoplastic resinous molding compositions, cast film compositions, paints and other finishes, sealants and the like.

### BACKGROUND OF THE INVENTION

Polymeric resins such as polyethylene, polypropylene, acrylonitrile-butadiene-styrene (ABS) and vinyl chloride have been widely used because of their mechanical, electrical and other properties. Polymeric resins are commonly compounded with fillers or pigments, such as clay, talc, calcium carbonate, titanium dioxide, barium sulfate, calcium sulfate, mica and the like, to improve their physical properties including rigidity, impact resistance, weather resistance, dimensional stability, flame retardance, painting property, adhesiveness and/or color-imparting property. However, the amount of such fillers used in polymer resin compositions is usually limited because more filler reduces the strength of the article formed from the resinous composition.

Other disadvantages of using fillers in polymer resin compositions may include difficulty in molding, due to reduced polymer flowability, and deteriorated product appearance, due to increases in surface defects, such as streaking and voids.

Formation defects such as streaking, discrete voids and/or continuous voids in the polymer product can be associated with the use of more filler. This is related to the compatibility between the filler and the polymeric resin. The surfaces of the fillers used in polymeric resins are hydrophilic (organophobic) while polymeric resins, particularly thermoplastic polyolefinic resins, are hydrophobic. This incompatibility translates into formation defects in the filled polymer product. When there is good interaction of the polymeric resin with the surface of the filler, i.e. the polymeric resin wets the surface of the filler; the products formed from the filled polymer composition usually have increased physical strength. However, poor interaction or wetting between the filler and the polymer resin results in decreased physical strength such as tear strength of thin films formed from filled polymer resin compositions results.

Other attempts have been made to improve the physical properties of filled polymer compositions including adding coupling agents to the filled polymer composition in order to more readily adhere the filler to the polymer and/or aid in dispersing the filler uniformly in the polymer matrix.

Treated fillers coated and/or mixed with coupling agents have been incorporated into moldable plastics to improve the physical properties of molded composites. Work has been done with regard to modifying the physical and mechanical properties of molded filled polymer compositions by altering the surface of fillers by chemically surface treating the fillers and incorporating such surface treated fillers into the moldable polymer matrix. Surface treating the filler means adding a chemical additive to the pigment in the form of an aqueous solution or aqueous dispersion that is added to an aqueous suspension that contains calcium carbonate prior to, simultaneously with, or subsequent to comminution, milling or further processing the pigment for use in polymeric resins.

Additionally, fillers such as calcium carbonate have been surface treated, surface modified, coated and/or mixed with dispersants such as, but not limited to, glycerin and/or saturated or unsaturated fatty acids, such as, but not limited to, butyric acid, oleic acid, stearic acid, lauric acid, myristic acid, palmitic acid, montanic acid, capric acid, isostearic acid, cerotic acid, behenic acid, organosilane coupling agents, organotitanates and zircoaluminates alone or in combination to improve the compounding with polymeric resins. However, problems can arise when too much or too little dispersant has been added to the filler and compounded with the polymeric resin.

Insufficient surface treatment of the filler can cause the screens of a compounding system to be plugged due to an inadequate dispersion of the filler/polymer resin composition. Also, inadequate dispersion of the filler in the polymeric resin can cause the formation of defects in a film such as streaks or voids ultimately causing problems when the composition is used in an end product application.

Too much surface treatment of the filler causes processing issues such as smoking, odors, excess voids, and excess volatiles during compounding.

It was found that by chemically surface treating the fillers with an amine inconsistencies in processing ability were reduced or eliminated.

Additionally, by surface treating the fillers melt flow rate was improved. Melt flow rate (MFR) is a measure in grams per 10 minutes wherein MFR equals 600 seconds per 10 minutes per time (600 sec/10 min/t) multiplied by the weight of extrudate (in grams), wherein “t” equals time of extrudate in seconds. Melt flow rate is the rate of extrusion of thermoplastics through an orifice at a prescribed temperature and load. Melt flow rate provides a means of measuring flow of a melted material that is used to differentiate resin grades as with, for example, polyethylene, or determine the extent of degradation of the plastic as a result of molding.

Several factors were found that influenced melt flow rate including the mixing or surface treatment temperature at which a dispersant was applied to the filler; amount of dispersant on the filler; surface treatment, coating, and/or mixing time; amount of fine fraction added to larger particles; type of dispersant applied to the filler; type of filler; type and amount of grinding aid used; particle size of filler; and whether various fillers were blended together.

The present invention provides for a filled polymeric resin composition wherein the filler has been surface treated with a dispersant to improve the fillers chemical compatibility with polymeric resins and to improve the physical properties of products formed from the filled polymer compositions.

Additionally, the present invention provides for a filled polymeric resin composition having improved melt flow rate and fusion time, which is the amount of time needed to react the filler and the polymeric resin.

Additional features will become apparent from the following detailed description of the embodiments of the present invention.

### SUMMARY OF THE INVENTION

The present invention provides for a filled polymeric resin composition for improving the melt flow rate of such composition.

Inorganic pigments used in polymeric resin filling applications are crushed and dried in a comminution or milling process producing a fine fraction which is surface treated, coated and/or mixed with an amine, such as, but not limited to, triethanolamine (TEA), triisopropanolamine (TIPA), dimethyl amine acetate, alkyl amine acetate, amine phenolate, monoethanolamine, diethanolamine, methyl diethanolamine, N-methylethanolamine, dimethylethanolamine, N-ethylethanolamine, ethyl-diethanolamine, N-propyl ethanolamine, N-propyl diethanolamine, N-butyl ethanolamine, N-butyl diethanolamine, tert-butylethanolamine, N-benzyl ethanolamine, morpholine, N-methyl morpholine, N-methyl morpholine oxide-50%, N-ethyl morpholine, N-formyl morpholine, and/or hydroxy ethyl morpholine and a dispersant, such as but not limited to, a glycerin and/or fatty acid, which is then compounded in polymer resin compositions.

Surface treating the filler with an amine results in a filled polymer composition having improved melt flow rate when compared with a filled polymer composition wherein the filler is not surface treated with an amine.

In order to improve melt flow rate and fusion time of filled polymer resin compositions, such as, but not limited to, polyethylene and polypropylene, research was done to find an additive that when used in conjunction with glycerin, fatty acids or other polymeric additives known in the art, such as, but not limited to, stearic acid, behenic acid or palmitic acid, processing issues would be reduced or eliminated.

The filler is surface treated with an additive such as a glycerin and/or a fatty acid prior to or subsequent to being surface treated with an amine and compounded with a polymeric resin. When the filler is surface treated with an amine, improvements in melt flow rate and fusion time are observed when compared with not surface treating the filler with an amine. The progress of the reaction is measured by changes in torque over time. The reaction of the filler and polymer resin is considered fused (complete) when a sharp increase in torque (fusion torque) is observed during the compounding.

Polymeric resins that can be compounded with the filler of the present invention include, but is not limited to, mono-olefin polymers of ethylene, propylene, butene and/or copolymers of the same. These can include low-density polyethylene (LDPE), linear low-density polyethylene (LLDPE) (ethylene-.alpha.-olefin copolymer), middle-density polyethylene (MDPE) and high-density polyethylene (HDPE); polypropylene resins such as polypropylene and ethylene-propylene copolymer; poly(4-methylpentene); polybutene; polybutadiene, polymethylpentene-1, polybutene-1, polypentene-1 and copolymers thereof; vinyl chloride resins, including vinyl chloride and vinyl chloride copolymers, such as vinyl chloride-vinyl acetate copolymer, vinyl chloride-vinylidene chloride copolymer, vinyl chloride-ethylene copolymer, copolymer resulting from grafting vinyl chloride to ethylene-vinyl acetate copolymer; styrene resins, such as polystyrene and acrylonitrile-butadiene-styrene copolymer; acrylic resins; engineering plastics, such as polycarbonate, polyamide, polyethylene terephthlate, polybutyrene terephthlate, polyphenylene oxide and polyphenylene sulfide alone or in combination with one another.

### DETAILED DESCRIPTION OF THE INVENTION

A filler such as, ground calcium carbonate, precipitated calcium carbonate, barium sulfate, calcium sulphate, barium carbonate, magnesium hydroxide, aluminum hydroxide, zinc oxide, calcium oxide, magnesium oxide, titanium oxide, silica, and/or talc, is crushed and dried in a comminution or milling process wherein a grinding aid is added to the crushed filler and the filler passed through a classifier, producing particles having a fine fraction of about a 25 micrometer (μm) top size and a median particle size of from about 1 μm to about 4 μm as measured by gravity sedimentation analysis using a Micromeritics Sedigraph 5100 from Micromeritics Corp., One Micromeritics Drive, Norcross, Ga. 30093-3620.

In the present invention, particles having a fine fraction of up to about a 25 micrometer (μm) top size and a median particle size of from about 1 μm to about 4 μm are surface treated, coated and/or mixed with an amine having a concentration of from about 0.05 percent by dry weight filler to about 1.0 percent by dry weight filler and a dispersant and then compounded with a polymeric resin.

Amines, such as, but not limited to, triethanolamine (TEA), triisopropanolamine (TIPA). dimethyl amine acetate, alkyl amine acetate, amine phenolate, monoethanolamine, diethanolamine, methyl diethanolamine, N-methylethanolamine, dimethylethanolamine, N-ethylethanolamine, ethyl-diethanolamine, N-propyl ethanolamine, N-propyl diethanolamine, N-butyl ethanolamine, N-butyl diethanolamine, tert-butyl ethanolamine, N-benzyl ethanolamine, morpholine, N-methyl morpholine, N-methyl morpholine oxide-50%, N-ethyl morpholine, N-formyl morpholine, and/or hydroxy ethyl morpholine may be used to surface treat the filler prior and/or during compounding with a polymeric resin.

The filler can be surface treated with an amine according to the present invention prior to being crushed and dried in a milling or comminution process or the filler may be surface treated with an amine during crushing of the filler in a milling or comminution process or surface treated with an amine subsequent to the milling process. For example, the amine may be added at a first stage of milling wherein the particle size of the filler is reduced to from about 10 inches to about 1000 micron top size, or a second stage of milling wherein the particle size of the filler is comminuted to from about 1000 microns to about 10 microns top size. During the second stage of milling an organic dispersing agent such as a glycerin and/or a fatty acid may be added so that the filler can be simultaneously milled and surface treated. An amine may also be added at this stage.

Additionally, the fine fraction, or particles having a median particle size of about 5 microns or less, can be admixed with particles having a median particle size larger than about 5 micron prior to compounding with the polymeric resin.

Milling of the filler may be carried out in either a wet or dry milling process, for example, a conventional ball mill, jet mill, micro mill, Cowles type dispersion mixer, kady mill, impingement type mill, sand or media mill or any other mill known in the art. Milling may be carried out by introducing slurry or powder of filler into a media mill containing grinding media such as glass, steel, ceramic, or other media known in the art, of a size from about 0.2 mm to about 5.0 mm.

An inorganic pigment used as a filler in polymeric resin compositions is surface treated, coated or admixed with a dispersant at a concentration of from about 0.5 percent by weight of dry filler to about 4.0 percent by weight of dry filler, prior to, simultaneously with or after being surface treated, coated or admixed with an amine compound.

The filler can also be milled or comminuted to a target median particle size of from about 4 microns to about 0.5 microns and treated with an amine prior to the addition of a dispersant and/or simultaneously with the dispersant and/or the amine may be added after dispersing the filler, as a post surface treatment.

In addition to a dispersant being added to the filler, a lubricant having a concentration of from about 0.01 percent by dry weight filler to about 2.0 percent by dry weight filler may be added to the composition. Any lubricant known in the art may be used and includes, but is not limited to, paraffin and hydrocarbon resin lubricants such as paraffin waxes, liquid paraffin, and polyethylene waxes; fatty acid lubricants such as stearic acid, hydroxystearic acid, mixed lubricants containing stearic acid, hardened oils; fatty acid amide lubricants such as stearoamides, oxystearoamides, oleyl amides, erucyl amides, ricinoleic amides, behenic amides, methylol amides, higher fatty acid monoamides, methylenebis-stearoamides, methylenebis-stearobehenic amides, ethylenebis-stearoamides, higher fatty acid bisamide type lubricants, stearoamide lubricants, and mixed lubricants containing an amide compound; fatty acid ester lubricants such as methylhydroxystearate, polyhydric alcohol fatty acid esters, saturated fatty acid esters, ester waxes, and mixed lubricants containing an ester compound; fatty acid ketone lubricants; aliphatic alcohol lubricants, e.g., higher alcohols, mixed lubricants containing a higher alcohol, and higher alcohol esters; mixed lubricants containing a partial ester of fatty acid and polyhydric alcohol such as glycerin fatty acid esters.

Fillers of the present invention are surface treated with additives known in the art and in combination with being surface treated with an amine, prior to or subsequent to compounding the filler with a polymeric resin to produce a filled polymeric composition having improved melt flow rates and fusion times.

Other embodiments of the invention will be apparent to those skilled in the art from a consideration of this specification or practice of the invention disclosed herein.

### EXAMPLES

The following non-limiting examples are merely illustrative of some embodiments of the present invention, and are not to be construed as limiting the invention, the scope of which is defined by the appended claims. All samples used in the following examples were surface treated, coated or admixed with a dispersant, i.e. stearic acid, prior to, compounding with a polymeric resin.

Calcium carbonate was comminuted using a Vibra-drum grinding mill from General Kinematics, 777 Lake Zurich Road, Barrington, Ill. 60010, and classified using a RSG ACS classifier from RSG, Inc., 119 Crews Lane, Sylacauga, Ala. 35150. Triethanolamine was added to the Vibra-drum grinding mill to enhance the grinding of the calcium carbonate. Additionally, stearic acid was admixed with the calcium carbonate in either a lab Henschel mixer or a production Henschel mixer located at Specialty Minerals Inc., Adams, Mass., either prior to, during, or subsequent to the calcium carbonate being surface treated with the triethanolamine.

The calcium carbonate was introduced into the Vibra-drum grinding mill while simultaneously adding from about 0.05 percent triethanolamine (TEA) by weight calcium carbonate to about 0.85 percent TEA by weight of calcium carbonate producing a surface treated calcium carbonate, which was sent a RSG classifier.

The surface treated calcium carbonate particles that had a particle top size greater than 10 microns was returned to the Vibra-drum grinding mill for additional comminution and the surface treated calcium carbonate having a particle top size less than 10 microns or the “fine fraction,” was collected as product.

The fine fraction was surface treated with stearic acid in a laboratory or a production Henschel mixer and compounded with a low-density polyethylene (LDPE). The filled polymer composition contained about 75 percent filler based on total composition and about 25 percent LDPE based on total composition. The LDPE used in this example was Dowlex™ 993 I, from Dow Chemical Company, 2030 Dow Center, Midland Mich., 48674 having a base level melt flow rate of 25 grams per 10 minutes.

Samples of surface treated calcium carbonate were compounded with the LDPE using two slightly different Brabender procedures.

“First Brabender” Procedure

A Brabender compounder, Brabender® OHG, Duisburg, Germany was heated to about 190 degrees Celsius and a Carver Press, Carver Inc, Wabash, Ind., was heated to about 204 degrees Celsius. A 55 gram filled polymeric resin sample was prepared by admixing about 41 grams of calcium carbonate, that had been surface treated with from about 0.05 percent to about 0.85 percent triethanolamine by weight of calcium carbonate, with about 14 grams of powdered polymeric resin having a melt flow rate of about 25 grams per 10 minutes. The sample was introduced into a Brabender compounder and compounded for about 2 minutes at about 50 revolutions per minute (rpm) and about 190 degrees Celsius. The compounded sample was removed from the Brabender and formed into a ball or sphere and pressed between two Mylar covered metal pressing plates of the heated Carver Press to produce a filled polymeric resin composition.

The filled polymeric resin composition was compressed at from about 1000 pounds per square inch (psi) to about 3000 psi, using 500 psi increments every 15 seconds. Once 3000 psi was reached compression was held for an additional 60 seconds. After cooling the Mylar covered metal pressing plates, the filled polymer resin composition was removed from the plates and tested for melt flow rate.

“Second Brabender” Procedure

A Brabender compounder, Brabender® OHG, was heated to 120 degrees Celsius and a Carver Press, Carver Inc, Wabash, Ind., was heated to about 204 degrees Celsius. An 80 gram filled polymeric sample was prepared by admixing about 61 grams of calcium carbonate, that had been surface treated with from about 0.34 percent to about 0.85 percent triethanolamine by weight of calcium, with about 19 grams powdered polymeric resin having a melt flow rate of about 5 grams per 10 minutes. The admixture was introduced into the Brabender compounder and compounded for a maximum of about 15 minutes at about 50 rpm and a temperature of about 120 degrees Celsius. Once it was determined the calcium carbonate and polymeric resin had fused, the sample was compounded for an additional 2 minutes and removed from the Brabender producing a filled polymeric resin composition.

The filled polymeric resin composition was formed into a ball or sphere and pressed between metal pressing plates of the heated Carver Press. The filled polymeric resin composition was compressed at from about 1000 pounds per square inch (psi) to about 3000 psi using 500 psi increments every 15 seconds. Once 3000 psi was reached compression was held for an additional 60 seconds. After cooling the plates, the filled polymeric resin composition was tested for color and melt flow rate.

The melt flow rate (melt index or melt density) was determined using the American Standardized Test Method (ASTM) D1238-95.

The following examples used the procedures outlined above for producing calcium carbonate particles surface treated with from about 0.34 percent to about 0.85 percent triethanolamine and compounded with LPDE resin. All fillers were surface treated, coated or admixed with an additive at indicated concentration levels.

### Example 1

### Ten Micron Particle Top Size Surface Treated With Triethanolamine (TEA)

TABLE 1 shows the relationship of melt flow rate and TEA concentration levels. When TEA is used to surface treat calcium carbonate having a 10 micron particle top size, at concentration levels of from zero percent to about 0.84 percent by weight calcium carbonate, the melt flow rate increased over 200 percent when the calcium carbonate was surface treated with TEA versus no surface treatment with TEA (higher melt flow rate numbers are better).

TABLE 1

| | Melt Flow Rate | Amount Triethanolamine |
|---|---|---|
| Sample | (grams per 10 minutes) | (percent - %) |
| 1 | 1.1 | <0.1 |
| 2 | 3.6 | 0.34 |
| 3 | 4.2 | 0.84 |

### Example 2

### Five Micron Particle Top Size Surface Treated With Triethanolamine (TEA)

The process was repeated using fillers having particles that were less than 5 microns in top size. The particles were surface treated with stearic acid and triethanolamine and tested for melt flow rate.

TABLE 2 shows increases in efficiency in melt flow rate with the addition of from about 0.34 percent to about 0.84 percent TEA to the calcium carbonate filler (Sample 2 and Sample 3).

TABLE 2

| | Amount | Melt Flow |
|---|---|---|
| | Triethanolamine | Rate |
| SAMPLE | (percent - %) | (g/10 min.) |
| Sample 1 A | Less than 0.1 | 1.70 |
| Sample 1 B | Less than 0.05 | 0.04 |
| Sample 1 C | Less than 0.05 | 0.00 |
| Sample 2 | 0.34 | 2.90 |
| Sample 3 | 0.84 | 4.10 |

TABLE 2 shows melt flow rate and fusion times of the filled polymeric resin composition produced by the process described above. When calcium carbonate was surface treated with concentration levels of about 0.1 percent by weight or higher TEA, an improvement of about 98 percent was seen and at concentration levels higher than about 0.1 percent had additional improvements from about 50 percent (Sample 1A verses Sample 2) to about 400 percent (Sample 1C verses Sample 3) in melt flow rate was observed over the filled polymeric resin compositions where the calcium carbonate was surface treated with less than about 0.05 percent TEA.

### Example 3

### Ten Micron Particle Top Size Surface Treated With Triethanolamine With Additional Processing Time

Calcium carbonate was surface treated with triethanolamine and a dispersant as described in Example 1 and processed for from about 30 minutes to about 240 minutes in a Henschel mixer.

TABLE 3 shows an improvement in melt flow rate of a filled polymeric resin composition when calcium carbonate is surface treated with TEA and subjected to increased processing time in the Henschel mixer.

A melt flow rate of about 4.0 grams per 10 minutes may be achieved by processing a filler that had been surface treated with about 0.34 percent for 240 minutes or by processing a filler that is surface treated with about 0.84 percent TEA and processed for about 30 minutes and compounded with a polymeric resin.

TABLE 3

| Time Processed in | Melt Flow Rate | Melt Flow Rate |
|---|---|---|
| Henschel Mixer | (g/10 min) | (g/10 min) |
| (minutes) | (0.34% TEA) | (0.84% TEA) |
| 30 | 2.9 | 4.1 |
| 60 | 3.3 | 4.4 |
| 90 | 3.2 | 4.5 |
| 120 | 3.4 | 4.7 |
| 180 | 3.5 | 5.1 |
| 210 | 3.7 | 5.0 |
| 240 | 3.8 | 4.7 |

Example 4 through Example 5 were processed according to the following procedure:

Calcium carbonate was ground in a heated roller mill to a top size of about one-millimeter. The one millimeter top size calcium carbonate exited the heated roller mill and was simultaneously surface treated, coated or admixed, with stearic acid at concentration levels of from about 0.4 percent by weight calcium carbonate to about 1.2 percent by weight calcium carbonate and triethanolamine at concentration levels of from zero percent by weight calcium carbonate to about 0.2 percent by weight calcium carbonate, prior to being fed into a ball mill.

The surface treated calcium carbonate was then fed into a ball mill charged with aluminum oxide media and processed (milled) for about 30 minutes. The calcium carbonate exiting the ball mill was classified in a Hosokawa classifier from Hosokawa Micron Powder Systems 10 Chatham Road, Summit, N.J. 07901.

Calcium carbonate particles coarser than about 10 microns were returned to the ball mill for additional processing until the calcium carbonate particles were finer than about 10 microns. Calcium carbonate particles finer than about 10 microns exiting the classifier were collected as product.

### Example 4

### Ball Mill Processing of Surface Treated Calcium Carbonate

Samples 1-5 in TABLE 4 were compounded with Chevron MarFlex™ 4517 LDPE-5 MI polymer resin, Chevron Philips Chemical Company, L.P. 10001 Six Pines Lane, The Woodlands, Tex. 77380, having a melt flow rate of 5.0 grams per 10 minutes (5 MI resin). The polymer resin was compounded with about 75 percent calcium carbonate by weight total composition and about 25 percent Chevron 4517 LDPE polymer resin by weight total composition.

TABLE 4 shows Samples 3, 4 and 5, that were surface treated with triethanolamine, had a melt flow rate of about 0.54 grams per 10 minutes to about 0.65 grams per 10 min versus Samples 1 and 2, not treated with triethanolamine, having a melt flow rate about 0.17 grams per 10 minutes. The fusion time (the time it took to fuse the polymer with calcium carbonate) for Samples 3, 4 and 5, which were surface treated, coated or admixed with triethanolamine was reduced by 59 percent on average.

TABLE 4

| | Melt Flow | |
|---|---|---|
| | Rate | Fusion Time |
| Sample | (g/10 min) | (Min) |
| Sample 1 No TEA | 0.15 | 2:40 |
| Sample 2 No TEA | 0.17 | 1:44 |
| Sample 3 0.1% TEA | 0.65 | 1:12 |
| Sample 4 0.1% TEA | 0.54 | 0:44 |
| Sample 5 0.2% TEA | 0.59 | 0:45 |

### Example 5

### Effect of Dispersant on Melt Flow Rate

Calcium carbonate was surface treated with stearic acid at concentration levels of from about 0.4 percent by weight calcium carbonate to about 1.2 percent by weight calcium carbonate and with triethanolamine at concentrations levels from zero percent by weight calcium carbonate to about 0.15 percent by weight calcium carbonate. These samples (Samples 1-7, TABLE 5) were compounded with Chevron MarFlex™ 4517 LDPE-5 MI resin (Chevron Philips Chemical Company, L.P. 10001 Six Pines Lane, The Woodlands, Tex. 77380) having a melt flow rate of 5.0 grams per 10 minutes (5 MI). The filled polymer composition was about 75 percent calcium carbonate by total weight composition and about 25 percent Chevron 4517 LDPE resin by total weight composition. Results are summarized in TABLE 5

TABLE 5

| | Melt Flow | Fusion | Amount |
|---|---|---|---|
| | Rate | Time | Stearic Acid |
| Sample | (grams/10 min.) | (min:sec) | (percent - %) |
| Sample 1 - No TEA | No flow | 5:52 | 0.4 |
| Sample 2 - No TEA | 0.36 | 7:54 | 0.8 |
| Sample 3 - No TEA | 0.39 | 7:18 | 1 |
| Sample 4 - No TEA | 0.24 | 7:32 | 1.2 |
| Sample 5 - 0.1% TEA | 0.68 | 1:32 | 0.8 |
| Sample 6 - 0.15% TEA | 0.73 | 1:36 | 0.8 |
| Sample 7 - 0.1% TEA | 0.58 | 1:42 | 0.6 |

TABLE 5 results show that polymeric resin compositions compounded with calcium carbonate having dispersant levels of from about 0.4 percent stearic acid by weight calcium carbonate to about 1.2 percent stearic acid by weight calcium carbonate, without triethanolamine surface treatment, does not significantly effect melt flow rate or fusion time of filled polymeric resin compositions (Samples 1-4).

However, when the stearic acid treated calcium carbonate is also surface treated with triethanolamine (Samples 5-7), melt flow rates are reduced by about 48 percent to about 300 percent versus samples that were not surface treated (Samples 1-4) with triethanolamine. Additionally, Samples 5-7 that had been surface treated with triethanolamine had fusion times of under 2 minutes while Samples 1-4 that had not been surface treated with triethanolamine had fusion times over 5 minutes.

### Example 6

### Effect of Addition Level of Triethanolamine on Melt Flow Rate of Filled Polymer

Calcium carbonate was surface treated with stearic acid at concentration levels of from about 0.4 percent by weight calcium carbonate to about 0.8 percent by weight calcium carbonate and with triethanolamine at concentrations levels from zero percent by weight calcium carbonate to about 0.40 percent by weight calcium carbonate. Additionally, in Sample 7 the TEA was replaced by Glycerin and in Sample 8, a mixture of Glycerin and TEA was used to surface treat the stearic acid treated calcium carbonate.

The samples (Samples 1-8, TABLE 6) were compounded with Chevron MarFlex™ 4517 LDPE-5 MI resin (Chevron Philips Chemical Company, L.P. 10001 Six Pines Lane, The Woodlands, Tex. 77380), which has a melt flow rate of 5.0 grams per 10 minutes (5 MI). The filled polymeric resin composition of surface treated calcium carbonate and polymeric resin consisted of about 75 percent calcium carbonate by weight of total composition and 25 percent Chevron 4517 LDPE resin by weight total composition.

Example 6 illustrates the effect concentration levels of triethanolamine on the surface of calcium carbonate, has on the melt flow rate of a filled polymer composition. Calcium carbonate surface treated with triethanolamine (Samples 3-6) show at least a 58 percent improvement in melt flow rate over the calcium carbonate that was not surface treated with triethanolamine (Samples 1 and 2). Glycerin was used to surface treat the filler in Sample 7 and showed about a 47 percent improvement in melt flow rate, but when 50 percent of the glycerin was replace with triethanolamine (Sample 8), over a 60 percent improvement was seen in melt flow rate.

TABLE 6
Melt Flow Rate Comparisons of Varying Amounts of Triethanolamine

| | | Amount | | |
|---|---|---|---|---|
| | Amount | Triethanol | Melt Flow | |
| Sample | Stearic Acid | amine (TEA) | Rate | Fusion Time |
| Number | (percent - %) | (percent - %) | (g/10 min.) | (minutes) |
| Sample 1 | 0.40 | 0.00 | 0.00 | 5:52 |
| Sample 2 | 0.80 | 0.00 | 0.30 | 5:54 |
| Sample 3 | 0.40 | 0.40 | 0.77 | 1:30 |
| Sample 4 | 0.60 | 0.05 | 0.72 | 3:54 |
| Sample 5 | 0.80 | 0.20 | 0.89 | 4:30 |
| Sample 6 | 0.80 | 0.30 | 1.00 | 2:26 |
| Sample 7 | 0.80 | 0.10% GLY* | 0.57 | 5:26 |
| Sample 8 | 0.80 | 0.05% TEA | .76 | 5:26 |
| | | 0.05% GLY* | | |

*GLY—glycerin

### Example 7

### No Media Milling, Triethanolamine added After Classification

Calcium carbonate was comminuted to a particle top size of from about 45 microns to about 30 microns in a heated roller mill. The resulting material was passed through a Hosokawa classifier, Hosokawa Micron Powder Systems, 10 Chatham Road, Summit, N.J. 07901, producing a product having a particle top size of about 10 microns. After classification, the calcium carbonate was surface treated with stearic acid and triethanolamine and processed in a Henschel mixer to a temperature of about 125 degrees Celsius.

The surface treated calcium carbonate was compounded with Dowlex™ 993 I, from Dow Chemical Company, 2030 Dow Center, Midland Mich., 48674, having a base level melt flow rate of 25 grams per 10 minutes (25 MI). The results can be seen in TABLE 7.

TABLE 7

| | Amount Stearic | Amount | |
|---|---|---|---|
| | acid | triethanolamine | Melt Flow Rate |
| | (percent - %) | (percent - %) | (grams/10 min) |
| Sample 1 | 1.00 | 0.00 | 1.95 |
| Sample 2 | 1.00 | 0.05 | 2.55 |
| Sample 3 | 1.00 | 0.10 | 2.75 |

Results show that surface treating calcium carbonate with triethanolamine after classification (Samples 2 and 3) results in an improved melt flow rate when compared with no triethanolamine surface treatment (Sample 1).

### Example 8

### Calcium Carbonate Surface Treated with Triisopropanolamine

Sample 1 was made in the following manner. Calcium carbonate was ground in a heated roller mill to a particle top size of about one-millimeter. The one millimeter particle top size calcium carbonate was surface treated with stearic acid at concentration levels of about 0.8 percent by weight calcium carbonate and fed into a low shear mixer. The surface treated calcium carbonate was then fed into a ball mill charged with aluminum oxide media and processed (milled) for about 30 minutes. The calcium carbonate exiting the ball mill was classified in a Hosokawa classifier from Hosokawa Micron Powder Systems 10 Chatham Road, Summit, N.J. 07901.

Calcium carbonate particles coarser than about 10 microns were returned to the ball mill for additional processing until the calcium carbonate particles were finer than about 10 microns. Calcium carbonate particles finer than about 10 microns exiting the classifier were collected as product.

The classified product was surface treated with zero percent triisopropanolamine (TIPA) (Sample 1), 0.1 percent triisopropanolamine (TIPA) (Sample 2) and 0.2 percent triisopropanolamine (Sample 3) by weight calcium carbonate and compounded with a low-density polypropylene (LDPE) resin.

The TIPA treated and untreated samples (Samples 1-3 of TABLE 8) were compounded with Chevron MarFlex™ 4517 LDPE-5 MI resin (Chevron Philips Chemical Company, L.P. 10001 Six Pines Lane, The Woodlands, Tex. 77380) having a melt flow rate of 5.0 grams per 10 minutes. The filled polymeric resin composition consisted of about 75 percent calcium carbonate and about 25 percent Chevron 4517 LDPE resin.

The results in TABLE 8 show that filled polymeric resin compositions, wherein the filler is treated with TIPA (Samples 2 and 3), exhibit a melt flow rate that is at least 50 percent improved over a filled polymeric resin composition wherein the filler was not surface treated with TIPA (Sample 1). Additionally, treating the filler with TIPA reduced the fusion time of the filler with polymer by 45 seconds (Sample 3) and 57 seconds (Sample 2).

TABLE 8

| | Amount | | |
|---|---|---|---|
| | Triisopropanolamine | Melt Flow Rate | Fusion Time |
| Sample | (TIPA) | (grams per 10 min.) | Minutes |
| Sample 1 | 0 | 0.31 | 4:25 |
| Sample 2 | 0.1% | 0.64 | 3:28 |
| Sample 3 | 0.1% | 0.73 | 3:40 |

### Example 9

### Filled Polymeric Resin for Cast Film

Polyethylene films containing about 60 percent calcium carbonate by weight total composition were produced using a Vertical 3 Roll Sheet Line, from Davis-Standard, Pawcatuck, Conn. The calcium carbonate was surface treated with about 1.4 percent stearic acid (SA) and 1.7 percent stearic acid by weight calcium carbonate (Samples 148.1 and 148.2) and with a combination of the stearic acid and 0.1 percent triethanolamine (TEA) (Samples 148.3 and 148.4) as shown in TABLE 9.

Samples 1, 2, 3 and 4 were compounded on a Leistritz twin screw compounder, using the conditions shown in TABLE 10. The polymer resin used in the compounding was Hifor SC-74840-X 4 M.I. polyethylene from Voridian of Kingsport, Tenn. Films were produced having thickness of from about 2 thousands of an inch (mils) to about 16 mils on the Davis-Standard, Vertical 3 Roll Sheet Line using the conditions shown in TABLE 11. Additionally, Irganox B-215 antioxidant was dusted on the polyethylene at concentration levels of about 0.1% by weight of the polyethylene subsequent to forming the films.

TABLE 9

| Sample Number | Type Surface Treatment |
|---|---|
| 1 | 1.4% Stearic Acid |
| 2 | 1.7% Stearic Acid |
| 3 | 1.4% Stearic Acid, 0.1% Triethanolamine |
| 4 | 1.7% Stearic Acid, 0.1% Triethanolamine |

TABLE 10
Leistritz Twin Screw Compounding Conditions

| Extruder | 34 millimeter, counter rotating |
|---|---|
| Temperature Profile (degrees Fahrenheit) | 180, 190, 200, 210, |
| | 220, 215, 215 (die) |
| Melt (die) Temperature (degrees | 220 |
| Fahrenheit) | |
| Output, (pounds per hour) | 12 |
| Revolutions Per Minute (RPM) | 150 |

*Nitrogen blanket on 2 feed ports, vacuum, 8 barrels

TABLE 11
Davis-Standard Vertical 3 Roll Sheet Line Conditions

| Extruder | 1.25 inch, 24:1, Maddock mixing screw |
|---|---|
| Extruder (RPM) | 40 |
| Breaker Plate Screens | 12/40/60/80/80/14 Mesh |
| Temperature Profile | 400, 450, 500-500(die) - Filled PE |
| (degrees Fahrenheit) | |
| Melt Temperature | 510 - Filled PE |
| (degrees Fahrenheit) | |
| Die Width (mils*) | 8 (with valve adapter) |
| Die Gap (mils) | Variable |
| | set 1-2 mils |
| Output (pounds per hour) | 12-15 |
| Barrel (psi) | 900-1000 |
| Roll Dimensions | 5 inch diameter, 10 inch width, chrome finish |
| Roll (degrees Fahrenheit) | 60-180 |
| Film thickness (mils) | 1-16 |

*mils—thousandth of an inch

The resultant polyethylene films were analyzed visually for porosity (holes in the film), surface smoothness (evenness of gloss of the film) and discoloration (brown spots in the film). The results are shown in TABLE 12.

TABLE 12

| | Film Properties | | |
|---|---|---|---|
| | | Smoothness | |
| Sample Number | Porosity | of Surface | Discoloration |
| 148.1 | some | uneven | few |
| 148.2 | most | uneven | present |
| 148.3 | least | best | present |
| 148.4 | some | good | present |

Results show that the films made by compounding with fillers treated with a combination of stearic acid and triethanolamine (Samples 3 and 4) gave the best balance of sheet porosity and smoothness of surface (evenness of gloss), when compared with films made by compounding with a filler that was surface treated with stearic acid alone.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

We claim:

1. A method for improving the melt flow rate of filled polymer resin comprising:
surface treating a filler with a dispersant and an amine; and
compounding the surface treated filler with a polymer resin.

2. The method according to claim 1 wherein the filler can be ground calcium carbonate, precipitated calcium carbonate, barium sulfate, calcium sulphate, barium carbonate, magnesium hydroxide, aluminum hydroxide, zinc oxide, calcium oxide, magnesium oxide, titanium oxide, silica, and/or talc.

3. The method according to claim 2 wherein the filler is ground calcium carbonate.

4. The method according to claim 1 wherein the amine can be a triethanolamine, triisopropanolamine, dimethyl amine acetate, alkyl amine acetate, amine phenolate, monoethanolamine, diethanolamine, methyl diethanolamine, N-methylethanolamine, dimethylethanolamine, N-ethylethanolamine, ethyl-diethanolamine, triisopropanolamine, N-propyl ethanolamine, N-propyl diethanolamine, N-butyl ethanolamine, N-butyl diethanolamine, tert-butyl ethanolamine, N-benzyl ethanolamine, morpholine, N-methyl morpholine, N-methyl morpholine oxide-50%, N-ethyl morpholine, N-formyl morpholine, hydroxy ethyl morpholine or any combination of the above.

5. The method according to claim 4 wherein the filler is surface treated with from about 0.05 to about 0.85 by weight filler with an amine.

6. The method according to claim 4 wherein the filler is surface treated with triethanolamine and/or triisopropanolamine.

7. The method according to claim 1 wherein the dispersant can be glycerin and/or saturated or unsaturated fatty acid, butyric acid, oleic acid, stearic acid, lauric acid, myristic acid, palmitic acid, montanic acid, capric acid, isostearic acid, cerotic acid, behenic acid, organosilane coupling agents, organotitanates and zircoaluminates alone or in combination.

8. The method according to claim 1 wherein the polymer resin can be mono-olefin polymers of ethylene, propylene, butene or copolymers; low-density polyethylene (LDPE), linear low-density polyethylene (ethylene-.alpha.-olefin copolymer), middle-density polyethylene and high-density polyethylene; polypropylene and ethylene-propylene copolymer; poly(4-methylpentene); polybutene; polybutadiene, polymethylpentene-1, polybutene-1, polypentene-1 and copolymers thereof; vinyl chloride resins, vinyl chloride-vinyl acetate copolymer, vinyl chloride-vinylidene chloride copolymer, vinyl chloride-ethylene copolymer, vinyl chloride ethylene-vinyl acetate copolymer; styrene resins and copolymers; acrylic resins; polycarbonate, polyamide, polyethylene terephthlate, polybutyrene terephthlate, polyphenylene oxide, polyphenylene sulfide; and/or combinations thereof.

9. The method according to claim 1 further comprising adding a lubricant during the compounding process.

10. The method according to claim 9 wherein the lubricant can be hydrocarbon resins, fatty acids, fatty acid amides, higher fatty acid bisamides, stearoamides, fatty acid esters, fatty acid ketones, aliphatic alcohols, and/or esters of fatty acid and polyhydric alcohol.

11. The method according to claim 10 wherein the fatty acid can be stearic acid and/or hydroxystearic acid.

12. A filled polymer resin composition comprising:
a filler surface treated with a dispersant and an amine; and
a polymer resin.

13. The filled polymer resin composition according to claim 12, wherein the filler can be ground calcium carbonate, precipitated calcium carbonate, barium sulfate, calcium sulphate, barium carbonate, magnesium hydroxide, aluminum hydroxide, zinc oxide, calcium oxide, magnesium oxide, titanium oxide, silica, and/or talc.

14. The filled polymer resin composition according to claim 13, wherein the filler is ground calcium carbonate.

15. The filled polymer resin composition according to claim 12, wherein the amine can be a triethanolamine, triisopropanolamine, dimethyl amine acetate, alkyl amine acetate, amine phenolate, monoethanolamine, diethanolamine, methyl diethanolamine, N-methylethanolamine, dimethylethanolamine, N-ethylethanolamine, ethyl-diethanolamine, triisopropanolamine, N-propyl ethanolamine, N-propyl diethanolamine, N-butyl ethanolamine, N-butyl diethanolamine, tert-butyl ethanolamine, N-benzyl ethanolamine, morpholine, N-methyl morpholine, N-methyl morpholine oxide-50%, N-ethyl morpholine, N-formyl morpholine, hydroxy ethyl morpholine or any combination of the above.

16. The filled polymer resin composition according to claim 15, wherein the amine can be triethanolamine or triisopropanolamine and/or a combination of both.

17. The filled polymer resin composition according to claim 12, wherein the dispersant can be glycerin and/or saturated or unsaturated fatty acid, butyric acid, oleic acid, stearic acid, lauric acid, myristic acid, palmitic acid, montanic acid, capric acid, isostearic acid, cerotic acid, behenic acid, organosilane coupling agents, organotitanates and zircoaluminates alone or in combination.

18. The filled polymer resin composition according to claim 17, wherein the dispersant is stearic acid.

19. The filled polymer resin composition according to claim 12, wherein the polymer resin can be mono-olefin polymers of ethylene, propylene, butene or copolymers; low-density polyethylene (LDPE), linear low-density polyethylene (ethylene-.alpha.-olefin copolymer), middle-density polyethylene and high-density polyethylene; polypropylene and ethylene-propylene copolymer; poly(4-methylpentene); polybutene; polybutadiene, polymethylpentene-1, polybutene-1, polypentene-1 and copolymers thereof; vinyl chloride resins, vinyl chloride-vinyl acetate copolymer, vinyl chloride-vinylidene chloride copolymer, vinyl chloride-ethylene copolymer, vinyl chloride ethylene-vinyl acetate copolymer; styrene resins and copolymers; acrylic resins; polycarbonate, polyamide, polyethylene terephthlate, polybutyrene terephthlate, polyphenylene oxide, polyphenylene sulfide; and/or combinations thereof.
